(19) United States
(12) Patent Application Publication
(10) Pub. No.: US 2017/0201145 A1
(43) Pub. Date: Jul. 13, 2017

(54) FEEDTHROUGH FOR HERMETIC APPLICATIONS

(71) Applicant: Hanon Systems, Daejeon (KR)

(72) Inventors: Eric Rooks, Bonn (DE); Andrea Gentile, Euskirchen (DE)

(21) Appl. No.: 15/404,374

(22) Filed: Jan. 12, 2017

(30) Foreign Application Priority Data
Jan. 12, 2016 (DE) 102016100394.8

(51) Int. Cl. H02K 5/22; H02K 15/10; H02K 15/12; H02K 5/10

(52) U.S. Cl. CPC H02K 5/225; H02K 5/10; H02K 15/10; H02K 15/12

(57) ABSTRACT

An electrical power feed-through system for external energy supply to an electric motor located within a sealed housing, in which one or more motor winding wires of the electric motor are each fed through an electrically insulating sleeve in a portion of an end segment of the motor winding wire, wherein the motor winding wire is enclosed in the segment by the sleeve forming a hermetic seal, and each sleeve has an at least partially conical contact area, which corresponds with an at least partially conical hole that passes through a dividing wall of the housing, into which hole the sleeve is pressed in such a way that the hole is sealed, and the motor winding wire that is fed through the sleeve (17) is fed though the dividing wall (15a).

### CROSS-REFERENCE TO RELATED PATENT APPLICATIONS

This patent application claims priority to German Pat. Appl. No. 10 2016 100 394.8 filed Jan. 12, 2016, the disclosure of which is hereby incorporated herein by reference in its entirety.

### FIELD OF THE INVENTION

The invention concerns an electrical power feed-through assembly for the external supply of energy to an electric motor located within a sealed housing and a process for the manufacture and assembly of such an electric power feed-through system.

### BACKGROUND OF THE INVENTION

This technology should be able to be used everywhere where electrical energy must be externally transported to a closed room. In the case of an electric compressor, electrical energy must be fed from a convertor to an electric motor which is located in a coolant circuit. Similar areas of application could, for example, be pumps or transformers.

Electric feed-through units made of glass/metal fused elements are widely used. These consist of an outer steel structure in which one or more glass structures have been melted. A glass structure, in turn, covers the actual metal, i.e. electroconductive, pins, and the glass portion electrically insulates the pin from external steel structures and serves as a hermetic cover at the same time.

The glass/metal fused element is mounted on the motor housing and requires either a separate seal and mounting material or it is pressed into the motor housing whereby the external surface of the steel structure forms a metal seal with the motor housing. The system is secured in the motor housing with a clip, for example, to prevent it from becoming detached, and is hermetically sealed with an O-ring, i.e. a circular sealing component. The installation of the glass/metal fused elements generally occurs prior to the stator installation.

Functionally, this means that, with respect to the assembly space, the pressurization and the pressure direction, it is preferable to mount the stator and electric feed-through unit in the same joining direction in the motor housing. In the case the stator has already been installed, only a limited easily accessible area remains for the installation of the glass/metal fused element. In the case of an internal rotor, this is within the stator internal diameter, and, in the case of an external rotor, it is outside of the stator external diameter. As a rule, however, the glass/metal fused element requires more installation space. For this reason, electric feed-through units are often placed outside of the motor diameter which requires additional space for the application and enlarges the overall installation space of the motor housing.

The assembly sequence can be changed as an alternative to this, whereby the glass/metal fused elements are first mounted in the housing and then the stator is pressed in. The feed-through unit is then behind the stator and is no longer freely accessible. This leads to a difficult assembly operation or, more specifically, to a blind operation in the subsequent contacting of the stator coil to the glass/metal fused elements.

A further disadvantage of the familiar glass/metal fused elements is the necessary, large housing cutouts that contribute to the weakening of the entire structure. This is especially relevant in high pressure applications such as, for example, a carbon dioxide compressor.

Furthermore, the difficult manufacturing process of the glass/metal fused elements in itself leads to higher tolerance of the electroconductive pins. The manufacturing process and the later application also limit the material selection for the current-carrying conductor to steel which does not possess good electrical properties. Lastly, the glass/metal fused elements, on account of the brittle features of glass, are very sensitive towards mechanical influences such as shear force and torsion, which can occur during the assembly process.

A hermetic connection module with a metal limb is known from U.S. Pat. No. 6,362,424 B1. It features a basically flat bottom and an edged portion that extends around the periphery of the bottom section, with the bottom section being provided with at least one opening. The connection module has a current-carrying pin which extends through the opening, and further has an insulating material layer which faces toward the bottom section and edge section of the limb and is arranged in closely aligned proximity thereto. The layer of insulating material has at least one opening that corresponds with the opening in the bottom section of the limb. The current-carrying pin also extends through the opening. An insulating pin sealant is provided, which extends between the periphery of the current-carrying pin and the periphery of the opening in the bottom sections and seals the pin in the opening. A layer retainer is provided to fasten the layer in a closely aligned position relative to the bottom section and the edge section of the limb, with the layer retainer being an insulating, liquid adhesive that hardens between the layer and the limb components and fills in the hollow areas in between.

In DE 33 24 466 A1, a current feed-through, particularly for refrigerators, is described, having an insulator through which electroconductive pins extend. The insulator consists of temperature-resistant material that is insensitive to chemicals and at least slightly elastic, in particular an elastomer, a thermoplastic or the like.

DE 30 09 186 A1 discloses an electroconductive feed-through through a hole in a high temperature-resistant and vacuum-proof insulating part, particularly consisting of ceramic, glass or a monocrystal, which feed-through is embodied as an active-solder insert that has been soldered into the hole or as a connection lead which is soldered into the hole by means of an active solder sleeve.

DE 10 2006 041 940 A1 describes an electrical feed-through for insertion into an opening of an implantable electric therapy device having an electrically insulating insulator through which at least one electroconductive connection pin passes, which is connected hermetically sealed to the insulator by means of a solder, the solder material being glass or glass ceramic.

Known from DE 10 2010 043 773 A1 is an electrical feed-through for hermetically sealed compressors, having an electroconductive connection pin and an elastic insulating component, which is pressure-tightly clamped in a housing opening by a mounting component. The materials of the connection pin and the insulating component are joined together by vulcanization so that the connection pin and the insulating component form one structural unit. The insulating component exhibits a circumferential, preformed protrusion in the form of an external sealing surface of an O-ring that positively corresponds with a groove in the housing opening.

Also known is a feed-through unit for the feeding of electrical contacts through a wall of a housing of an electric motor, which feed-through unit has a pin made of an electroconductive material, which is enclosed by an electrically insulating sleeve, wherein the pin has an at least partially conical contact surface for the area to pass through the wall of the housing and can be arranged, along with the sleeve enclosing it, in an at least partially conical hole that passes through the housing wall. In this case, the electrically insulating sleeve can consist of a thermoset, or duromer, insulator.

### SUMMARY OF THE INVENTION

The present invention is directed to the object of operating an electric motor within a sealed housing, but supplying it with power from outside, thereby reducing costs in comparison with previously known systems and increasing the quality without compromising the main function, which is to transport electrical power in a secure and sealed manner from one room to another.

The object of the invention is accomplished with an electrical power feed-through system for the external supply of energy to an electric motor located within a sealed housing as shown and disclosed herein.

According to the invention, one or more motor winding wires of the electric motor are each fed through an electrically insulating sleeve in a segment of an end portion of the motor winding wire, with the motor winding wire in the said segment being surrounded by the sleeve forming a hermetic seal. Each sleeve has an at least partially conical contact area that corresponds to an at least partially conical hole, which passes through a dividing wall of the housing and into which the sleeve is pressed in such a manner that the hole is sealed and the motor winding wire that is fed through the sleeve is fed through the dividing wall.

Rather than using a separate pin as a conductor, as in the established prior art, the motor winding wire of the electric motor is fed directly through the at least partially conical sleeve and can in this way assume the main function of the pin. As a result, the previously necessary ports from the motor winding wire to the pin are omitted and the connection from the pin to the circuit board of a convertor of a power electronics module can be configured more simply.

In this way, an electric motor can be operated within a sealed housing, but can be externally supplied with energy. In the case of pressure differences inside and outside of the sealed housing, there is a certain direction in which the diameter of the at least partially conically formed hole increases. The larger diameter of the conical surface points inward towards the inside of the housing in the case of a pressurized system, and outward in the case of a lower pressure or a vacuum inside the housing.

According to advantageous embodiments of the invention, the electrically insulating sleeve is successful in hermetically enveloping the motor winding wire in that either the electrically insulating sleeve material is overmolded in the form of a sleeve around the motor winding wire, or the motor winding wire is bonded into a preformed sleeve that is furnished with a fitting hole.

According to an especially advantageous embodiment of the invention, the sleeve consists at least partially of a thermoset as the insulating sleeve material. The thermoset sleeve provides the electrical insulation between the motor winding wire and the housing. The insulation, with respect to the housing, can consequently be improved. Furthermore, the thermoset is in a position to offset housing deformations caused by internal pressure and thermal extensions much better than conventional brittle glass feed-through units can; that is, an improvement in the mechanical robustness of the electrical feed-through system can be achieved as compared with glass/metal feed-throughs.

Due to the simple application and the low price, a feed-through assembly according to the invention can also be of interest for semi-hermetic or non-hermetic applications. Should pressure and thermal demands be low, the thermoset can be replaced by a thermoplastic or an elastomer.

According to one embodiment, an initial, internal layer of the sleeve, which is molded directly around the motor winding wire, consists of a soft component, preferably an elastomer. A hard component, preferably a thermoset, is then overmolded around this soft component.

According to an advantageous embodiment of the invention, the segment of the motor winding wire that is enclosed or overmolded by the sleeve is compressed in form.

According to another advantageous embodiment of the invention, the ends of the motor winding wires that are located outside of the housing are electrically connected to a power electronic module. In this, the ends of the motor winding wires can be connected to a circuit board of a convertor through a solder connection. Preferably, the circuit board is in contact with a surface directed inwardly, i.e. towards the dividing wall, at the outermost end faces of the sleeve.

An additional aspect of the invention concerns a process for the manufacture and assembly of the said electrical power feed-through system for an external supply of energy to an electric motor positioned within a sealed housing, encompassing the process steps:
a₁) overmolding of one or more motor winding wires each in a segment just before the end of the motor winding wire with a sleeve material with the formation of an at least partially conical sleeve or
a₂) feeding an end segment of the respective motor winding wire into a preformed, at least partially conical sleeve which is provided with a fitting hole, and adhering the enclosed segment of the motor winding wire in the sleeve,
b) pressing the one or more sleeves into one or more similarly at least partially conical holes that pass through a dividing wall in the sealed housing.

The process advantageously includes as another process step c) the manufacture of an electrical direct connection of the one or more motor winding wires at the end of the respective motor winding wire that is outside the housing to a power electronic module.

According to a preferred process variant, shortly before their ends, the motor windings are either overmolded with a thermoset in the form of a conical sleeve or adhered in a preformed conical sleeve which is furnished with a fitting hole. The thermoset sleeves are then pressed into similarly conical openings in the housing. The ends of the motor windings can then be electrically connected to the power electronic module. This can be realized, for example, by indirectly soldering either into or onto a circuit board for a convertor.

A favorable self-centering of the sleeves during the assembly process on account of the conical shape creates less position tolerance than in glass feed-throughs, which has a positive effect on the quality of the unit.

Furthermore, the electrical power feed-through system of the invention, or the process of its manufacture and assembly, offers further advantages over glass feed-throughs or feed-throughs with conical contact pins. For instance, fewer electromechanical ports, such as plug and solder connections, are necessary. Additionally, material can be saved not least because of the omission of contact pins and contact jacks. With respect to the process, it is an advantage that fewer steps are required for the assembly.

The feed-through system can, according to the invention, be used in a brushless DC motor which is conceivable as an internal rotor configuration, in which case the rotor is located within the stator or as an external rotor configuration, in which case the rotor is outside of the stator.

Appropriate applications for the concept are numerous. Among the possibilities are applications in the automotive industry, for example in AC compressors, oil, water and gasoline pumps and in hydraulic devices, such as power steering or ABS pumps, as well as a variety of other applications that have nothing to do with automobiles.

### BRIEF DESCRIPTION OF THE DRAWINGS

Further details, features and advantages of embodiments of the invention stem from the following description of embodiment examples with reference to the corresponding illustrations. Shown are:

FIG. 1: the parts of an electrical power feed-through system for the external energy supply to an electric motor located within a sealed housing, prior to assembly, prior art,

FIG. 2: an electrical power feed-through system for the external energy supply to an electric motor located within a sealed housing after the assembly of the parts, prior art,

FIG. 3: the parts of an electrical power feed-through system for the external energy supply to an electric motor located within a sealed housing, before the assembly of the parts,

FIG. 4: an electrical power feed-through system for the external energy supply to an electric motor located within a sealed housing after the assembly of the parts, and

FIG. 5A: an overmolded or adhered motor winding,

FIG. 5B: a compressed, overmolded motor winding, and

FIG. 5C: a motor winding overmolded with a hard component and a soft component.

### DETAILED DESCRIPTION OF EMBODIMENTS

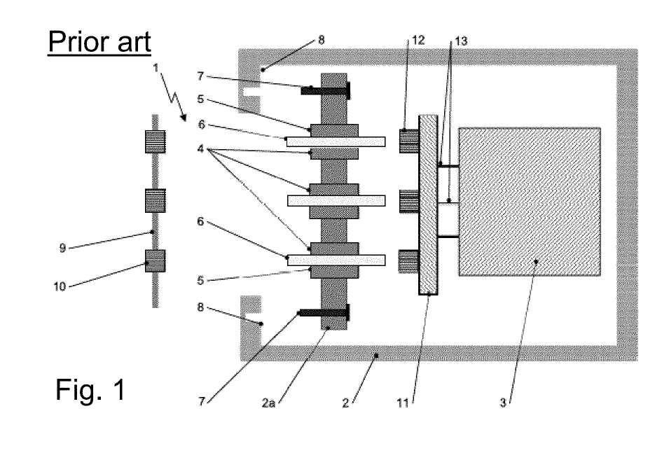

FIG. 1 schematically shows the parts of an electrical power feed-through system 1, known from the prior art, for the external energy supply to an electric motor 3 located in a sealed housing 2, prior to the assembly of the parts for system 1. Here the power feed-through runs through a dividing wall 2a of the housing 2.

The power feed-through system 1 features here several feed-through units 4 made of glass/metal fused elements 4 that are placed within holes that pass through the dividing wall 3a. The feed-through units 4 each consist of an external steel structure 5, in each of which a glass structure 6 has been fused. The glass structures 6, in turn, comprise the actual metal, i.e. electroconductive pins, wherein a glass structure 6 electrically insulates one pin each from the external steel structure 5 and serves as a hermetic cover at the same time.

The dividing wall 3a is designed to be mounted. The mountable dividing wall 3a can be fastened on the interior wall segments 8 of the housing 3 with the aid of fasteners 7 placed around an opening of the housing 3, thereby closing the opening of the housing 3.

A circuit board 9 with stamped contact parts 10 is located outside the housing 3. A stator grid 11 is connected in the interior of the housing 2 to the electric motor 3 situated in the interior of the housing 2, which stator grid 11 has contact parts 12, wherein the stator grid 11 is connected to the ends of winding wires 13 of the stator of the electric motor 3, hereinafter called motor winding wires 13, so that an electrical connection exists between the motor winding wires 13 and the contact parts 12. During assembly, the glass structures 6 and electroconductive pins are connected on the outside to the contact parts 10 of the circuit board 9 and inside the housing to the contact parts 12 of the stator grid 11, so that the power supply to the electric motor 3 through the dividing wall 2a of the housing 2 is ensured.

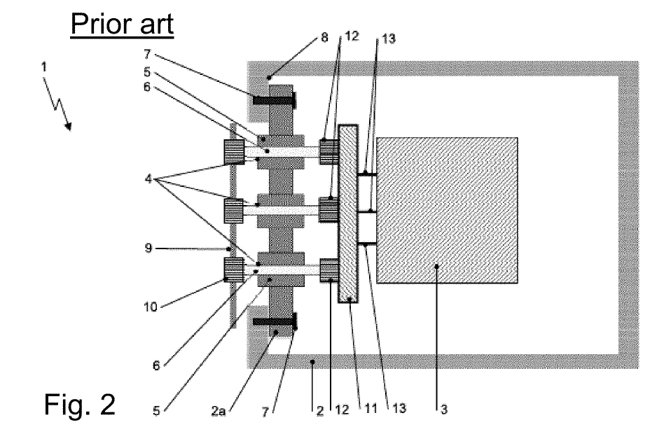

FIG. 2 shows the corresponding power feed-through system 1 for an electrical power feed-through through a dividing wall 2a of a housing 2 to an electric motor 3 in the assembled form. Here the dividing wall 2a is fastened to the interior wall portions 8 of the housing 3 with the aid of fasteners 7. The feed-through units 4 are connected, on the one hand, to the contact parts 10 of the circuit board 9 and, on the other hand, to the contact parts 12 of the stator grid 11, so that an electrical connection from the contact parts 10 of the circuit board 9 is produced via the electroconductive pins in the glass structures 6 and via the contact parts 12 of the stator grid 11 up to the motor winding wires 13.

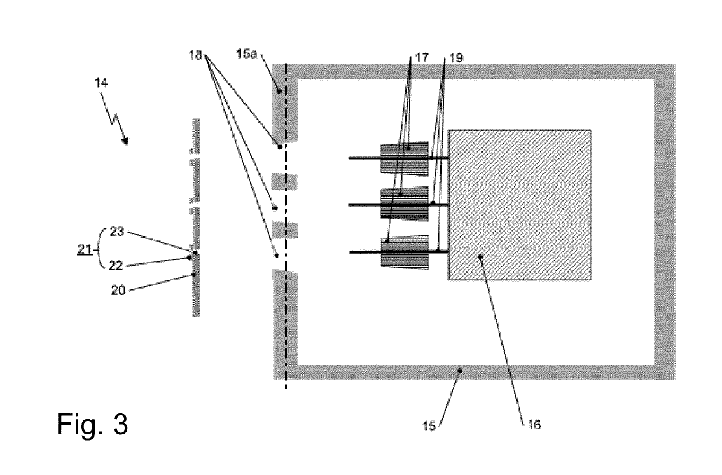

FIG. 3 schematically shows an electrical power feed-through system 14, according to the invention, for the external energy supply to an electric motor 16 located within a sealed housing 15 prior to assembly. This system 14 comprises one or more conical sleeves 17 of an insulating material, which correspond with conical holes 18 in a dividing wall 15a of the housing 15. The conical sleeves 17 each hermetically enclose a segment of a motor winding wire 19 of the electric motor 16 shortly before the end of the motor winding wire 19. For this purpose, the motor winding wires 19, shortly before the end thereof, are either overmolded with a thermoset as electrically insulating material in the form of the conical sleeve 17 or adhered in a preformed conical sleeve 17 that is furnished with a hole suitable for the motor winding wire 19. The ends of the motor winding wires 19 can then be electronically connected to a power electronic module. This can, for example, be realized by indirectly soldering the ends of the motor winding wires 19 into/onto a circuit board 20. For this purpose, the circuit board 20 has several pads 21, i.e. several holes 23 enveloped in a metal 22 or a metal alloy 22, for example copper or brass.

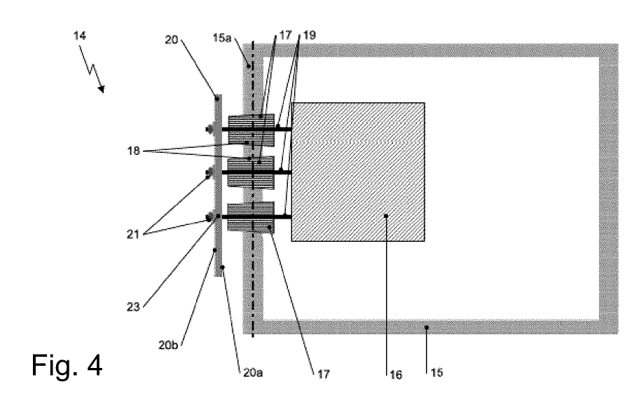

FIG. 4 schematically shows the one electrical power feed-through system 14, according to the invention, for the external energy supply to an electric motor 16 located in a sealed housing 15, in its assembled state. In the example shown in FIG. 4, the circuit board 20 lies with a surface 20a directed inwardly, i.e. directed towards the dividing wall 15a, at the outermost end faces of the conical sleeves 17 or, as shown in FIG. 4, not far removed from these. Each of the sleeves 17 enclosing a segment each of a motor winding wire 19 shortly before the end of the motor winding wire 19 is pressed into one of the conical holes 18 that penetrates the dividing wall 15a. Following the sleeves 17, i.e. outside of the housing 15, the motor winding wires 19 are fed through the holes 23 of the pads 21, with the ends of the motor winding wires 19 forming a solder connection with the circuit board 20 on the opposite surface 20b of the circuit board 20 at the pads 21, or being soldered therein. The feed-through system 1 provides, in this way, a direct connection from the circuit board 20 to the electric motor 16 for its electrical energy supply to the electric motor 16, which supply runs via one or more motor winding wires 19 of the electric motor 16 through the sealed dividing wall 15a of the housing 15.

In the process, the sleeves 17 and the enclosed motor winding wire 19 form a feed-through unit in which the motor winding wire 19, in contrast to the prior art, is fed directly through the conical sleeve 17 instead of a separate pin of the motor winding wire 19, and thus assumes the main function of the pin.

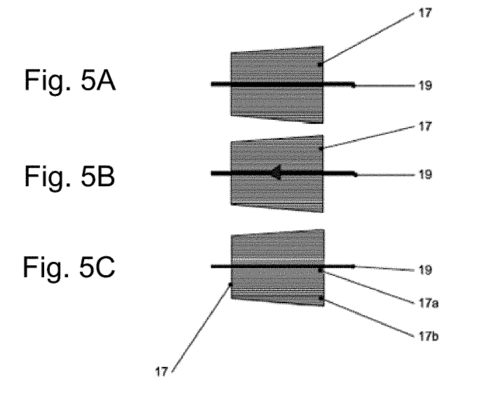

FIGS. 5A-C schematically show diverse variants for the realization of the feed-through unit consisting of a conical sleeve 17 and the motor winding wire 19 fed through it. FIG. 5a shows a motor winding wire 19 that is overmolded by the material of the sleeve 17, preferably a thermoset, or is adhered into a preformed sleeve 17.

FIG. 5B shows a feed-through unit consisting of a motor winding wire 19 overmolded with a material of the sleeve 17, which wire is embodied as compressed at the overmolded area.

A feed-through unit with a multi-layered sleeve or a sleeve with many components is represented in FIG. 5C. Here, an initial, internal layer 17a, with which the motor winding wire 19 has been directly overmolded, can consist of a soft component 17a such as, for example, an elastomer such as Viton™. The inner layer is itself overmolded by a second, external layer 17b, preferably consisting of a thermoset component 17b.

### REFERENCE SIGN LIST

1 Electrical power feed-through system (prior art), feed-through system
2 Housing (prior art)
2a Dividing wall (prior art)
3 Electric motor (prior art)
4 Feed-through unit (prior art)
5 Steel structure (prior art)
6 Glass structure (prior art)
7 Fastener (prior art)
8 Internal wall segments (prior art)
9 Circuit board (prior art)
10 Contact parts of the circuit board 9 (prior art)
11 Stator grid (prior art)
12 Contact parts of the stator grid 11 (prior art)
13 Motor winding wire (prior art)
14 Electric power feed-through system
15 Housing
15a Housing wall, dividing wall
Electric motor
Sleeve
17a Internal layer of sleeve, soft component
17b External layer of sleeve, thermoset component
18 Hole
19 Motor winding wire
20 Circuit board
20a Surface of the circuit board
20b Surface of the circuit board
20 Pads on the circuit board
21 Metal of the pads
22 Holes of the pads

What is claimed is:

1. An electrical power feed-through system comprising:
an electric motor located within a sealed housing, the electric motor receiving an external energy supply from the electrical power feed-through system;
a motor winding wire disposed in the electric motor and fed through an electrically insulating sleeve in a portion of an end segment of the electrically insulating sleeve, wherein the motor winding wire is enclosed in the segment of the electrically insulating sleeve forming a hermetic seal, and wherein the electrically insulating sleeve has an at least partially conical contact area which corresponds with an at least partially conical hole through a dividing wall of the housing, the electrically insulating sleeve pressed into the hole wherein the hole is sealed and the motor winding wire fed through the electrically insulating sleeve is fed through the dividing wall.

2. The electrical power feed-through system according to claim 1, wherein the electrically insulating sleeve hermetically encloses the motor winding wire, and wherein the motor winding wire is overmolded with a material forming the electrically insulating sleeve or adhered into the electrically insulating sleeve preformed and provided with a fitting hole.

3. The electrical power feed-through system according to claim 1, wherein the electrically insulating sleeve at least partially consists of a thermoset as a material forming the electrically insulating sleeve.

4. The electrical power feed-through system according to claim 3, wherein an initial, internal layer of the electrically insulating sleeve with which the motor winding wire has been directly overmolded consists of a first component formed from an elastomer, the internal layer overmolded with a second, external layer consisting of a second component formed from a thermoset, the first component softer than the second component.

5. The electrical power feed-through system according to claim 1, wherein the motor winding wire is compressed in the segment enclosed by the electrically insulating sleeve.

6. The electrical power feed-through system according to any of claim 1, wherein an end of the motor winding wire located outside of the housing is connected to a power electronic module.

7. The electrical power feed-through system according to claim 6, wherein the end of the motor winding wire is electrically connected to a circuit board of a convertor via a solder connection.

8. The electrical power feed-through system according to claim 7, wherein the circuit board is in contact with a surface directed towards the dividing wall at an outermost end face of the electrically insulating sleeve.

9. A process for the manufacture and assembly of an electrical power feed-through system for an external energy supply for an electric motor located within a sealed housing, the process comprising the steps of:
a₁) overmolding each of one or more motor winding wires in a segment shortly before an end of the one or more motor winding wires with a sleeve material to form an at least partially conical sleeve, or
a₂) feeding an end of each of one or more motor winding wires into a preformed, at least partially conical sleeve provided with a fitting hole, and adhering the end segment of the one or more motor winding wires in the sleeve, and
b) pressing the sleeves of each of the one or more motor winding wires into at least partially conical holes passing through a dividing wall of the sealed housing.

10. The process according to claim 9, further comprising the step of:
c) providing an electrical direct connection of the one or more motor winding wires at the end of the motor winding wire outside of the sealed housing to a power electronic module.
